(19) United States
(12) Patent Application Publication
(10) Pub. No.: US 2015/0130945 A1
(43) Pub. Date: May 14, 2015

(54) SMART HELMET

(71) Applicant: CHIUN MAI COMMUNICATION SYSTEMS, INC., New Taipei (TW)

(72) Inventors: CHIA-CHEN YU, New Taipei (TW); BO-HAN CHU, New Taipei (TW); HOW-WEN CHIEN, New Taipei (TW)

(21) Appl. No.: 14/539,040

(22) Filed: Nov. 12, 2014

(30) Foreign Application Priority Data
Nov. 14, 2013 (CN) 201310562894.9

(51) Int. Cl. A42B 3/30; H04R 1/46; H02J 1/00; G01C 21/00; G01S 19/13; H04N 7/18; H04R 1/10

(52) U.S. Cl. CPC A42B 3/30; H04N 7/181; H04R 1/46; H04R 1/10; G01C 21/00; G01S 19/13; H02J 1/00; H04R 2201/023; H04R 2460/13
USPC 348/158; 2/424; 381/151; 701/491

(57) ABSTRACT

A smart helmet includes a helmet shell, a visor, and a projector mounted on the helmet shell. The helmet shell defines an internal cavity and a passage communicating with the internal cavity. The internal cavity is configured to receive an user's head. The visor is rotatably coupled to the helmet shell, and is configured to expose or cover the passage. The projector is configured to introduce content for display onto the visor.

### FIELD

The subject matter herein generally relates to helmets, and particular to a smart helmet.

### BACKGROUND

Helmets and other protective headgear have evolved over the years. It is not uncommon for individuals to wear protective headgear when they are, for example, riding bicycles, riding horses, skiing and skating, as well as for other general safety purposes. Helmets have the primary function of protecting the head of a person from an injury that may be sustained while engaged in work, sports and other activities. Moreover, as outdoor activities have increased in popularity, the need emerged for multifunctional helmets.

### BRIEF DESCRIPTION OF THE DRAWINGS

Implementations of the present technology will now be described, by way of example only, with reference to the attached figures.

FIG. 1 is an diagrammatic view of one embodiment of a smart helmet.

FIG. 2 is a block diagram of the smart helmet as shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “inside” indicates that at least a portion of a region is partially contained within a boundary formed by the object. The term “outside” refers to a region that is beyond the outermost confines of a physical object. The term “comprising” when utilized, means “including, but not necessarily limited to”; it specifically indicates open-ended inclusion or membership in the so-described combination, group, series and the like.

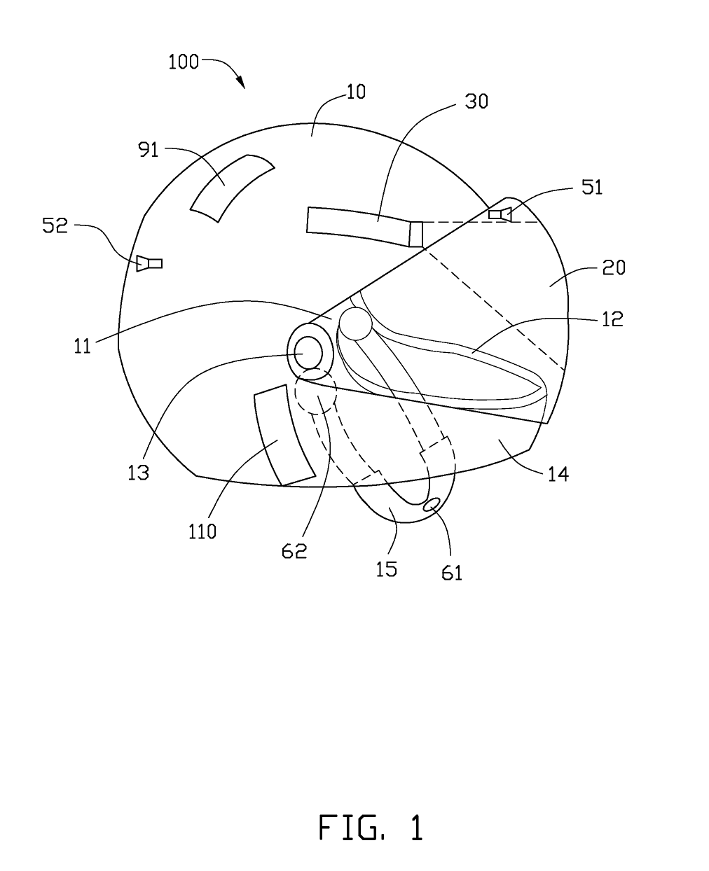

FIG. 1 illustrates an isometric view of one embodiment of a smart helmet 100. The smart helmet 100 includes a helmet shell 10, a visor 20, and a projector 30. The helmet shell 10 defines an internal cavity 11 and a passage 12 communicating with the internal cavity 11. The internal cavity 11 is configured to receive the head of a user wearing the helmet 100. The passage 12 is configured to expose eyes of the user. The visor 20 is rotatably coupled to the helmet shell 10, and configured to expose or cover the passage 12. The projector 30 is mounted on the helmet shell 10, for example, the projector 30 can be mounted at a top of the internal cavity 11 facing the visor 20, and is configured to introduce content for display onto the visor 20, such that, the user wearing the helmet 100 can view a surrounding environment combined with the displayed content. The visor 20 also can be a lens or a transparent eyeshield. The projector 30 can be a nano-projector, pico-projector, micro-projector, femto-projector, a laser-based projector, a holographic projector, and the like.

Optionally, the smart helmet 100 includes one or more hinges 13 coupled with the visor 20 and the helmet shell 10, which allow movement of the visor 20 relative to the helmet shell 10, for example to expose or cover the eyes and face of the user wearing the smart helmet 100. In some embodiments, visor 20 may rotate up and down along the outside of the helmet shell 10, and in some embodiments, the visor 20 may rotate up and down along the inside of the helmet shell 10.

The helmet shell 10 may include a chin bar 14 and a band 15. The chin bar 14 is defined adjacent to the passage 12, and extends generally in front of a mouth or chin of the user for hold the smart helmet 100 in place relative to the user's head. The band 15 is rotatably mounted to the helmet shell 10. The band 15 can fit around a jaw of the user to further hold the smart helmet 100 in place relative to the user's head. Two ends of the band 15 can be rotatably received into the internal cavity 11.

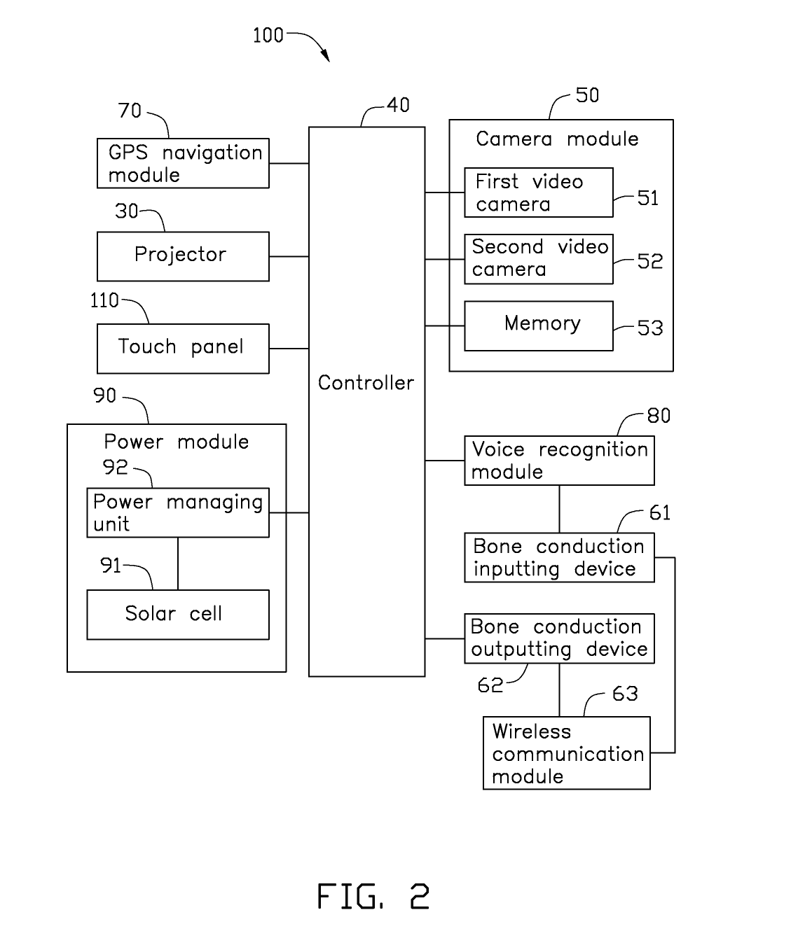

FIG. 2 illustrates a block diagram of the smart helmet 100. As illustrated in FIG. 2, the smart helmet 100 further includes a controller 40 and a camera module 50 including a first video camera 51, a second video camera 52, and a memory 53, all of which are electronically coupled to the controller 40. The first video camera 51 is mounted on a front portion of the helmet shell 10 (see FIG. 1), and configured to pick up scenes of the front of the helmet shell 10. The second video camera 52 is mounted on a rear portion of the helmet shell 10 (see FIG. 1), and configured to pick up scenes of the rear of the helmet shell 10. The memory 53 is configured to stored the video data took by the first and second video cameras 51 and 52 under the control of the controller 40.

The smart helmet 100 is further provided with a bone conduction inputting device 61, at least one bone conduction outputting device 62, and a wireless communication module 63 electronically coupled to both the bone conduction inputting and outputting device 61 and 62. In one embodiment, the bone conduction inputting device 61, such as a bone conduction microphone, is mounted on a substantially middle portion of the band 15. The smart helmet 100 includes two conduction outputting devices 62 that are positioned in the internal cavity 11 and adjacent to two ends of the band 15 respectively. When smart helmet 100 is held in place relative to the user, the bone conduction inputting device 61 will closely touch the skin of the neck of the user. The two conduction outputting devices 62 will closely touch the ears of the user respectively. The bone conduction inputting device 61 is configured to convert sound of the user wearing the smart helmet 100 to be output into an electrical wave signal. The wireless communication module 63 is configured to receive the electrical wave signal and transmit the electrical wave signal out and/or receive an external electrical wave signal. The bone conduction outputting device 62, such as a bone conduction earphone, is configured to receive the external electrical wave signal sent by the wireless communication module 63, and covert the electrical wave signal into a vibrating wave which can be transmitted into ear of the user by bone conduction. For example, the wireless communication module 63 can communicate with a wireless communication module, such as a mobile phone, a tablet computer, by Bluetooth or WiFi technology, such that, the user wearing the smart helmet 100 can make phone calls and/or listen to the music/radio through the bone conduction inputting device 61, the bone conduction outputting device 62, and the wireless communication module 63.

The smart helmet 100 is further provided with a global position system (“GPS”) navigation module 70 that is electronically coupled to the controller 40. The GPS navigation module 70 is configured to generate navigation data of the smart helmet 100, and output the navigation data to the controller 40, the navigation data includes moving picture guide data and voice guide data. The controller 40 is electronically coupled to the projector 30, and is configured to provide navigation content for display (such as moving picture guide) according to the navigation data. The navigation content for display is then forward to the projector 30 to be introduced to the visor 20, such that, the user wearing the helmet 100 can view a surrounding environment combined with the navigation data. In addition, the controller 40 is further electronically coupled to the bone conduction outputting device 62, and is further configured to handing voice guide data, and output the voice guide data to the bone conduction outputting device 62.

The smart helmet 100 further includes a voice recognition module 80 that is electronically coupled to the controller 40 and the bone conduction inputting device 61. The voice recognition module 80 is configured to recognize commands contained in the electrical wave signals output from the bone conduction inputting device 61, and transmit the commands to the controller 40. The controller 40 is configured to execute the commands. For example, the controller 40 can regulate the navigation content for display in response to the commands.

The smart helmet 100 is further provided with a power module 90 including at least one solar cell 91 and a power managing unit 92 electronically coupled to the at least one solar cell 91. The solar cell 91 is mounted on an outer surface of the helmet shell 10 (see FIG. 1), and is configured to convert solar power into electric power. The power managing unit 92 is configured to receive the electric power, and convert the electric power into working voltages which is forward to the electronic components of the smart helmet 100, such as the projector 30, the controller 40, the first and second video cameras 51 and 52.

A touch panel 110 mounted on the outer surface of the helmet shell 10 (see FIG. 1) is further included. The touch panel 110 is electronically coupled to the controller 40, and configured to input commands to the controller 40. For example, the touch panel 110 can input a command for activating/deactivating the projector 30, and input a destination position of the GP S navigation module 70.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A smart helmet comprising:
a helmet shell defining an internal cavity and a passage communicating with the internal cavity, the internal cavity configured to receive a user's head;
a visor rotatably coupled to the helmet shell, the visor configured to perform one of exposing or covering the passage; and
a projector mounted on the helmet shell, the projector configured to introduce content for display onto the visor.

2. The smart helmet of claim 1, further comprising a controller electronically coupled to the projector and a global position system (“GPS”) navigation module electronically coupled to the controller, wherein the GPS navigation module is configured to generate navigation data of the smart helmet, and output the navigation data to the controller; the controller is configured to handing navigation content for display according to the navigation data, and output the navigation content for display to the projector.

3. The smart helmet of claim 2, further comprising a camera module that comprises a first video camera, a second video camera, and a memory, all of which are electronically coupled to the controller; wherein the first video camera is mounted on a front portion of the helmet shell, and configured to pick up scenes of the front of the helmet shell; the second video camera is mounted on a rear portion of the helmet shell, and configured to pick up scenes of the rear of the helmet shell; the memory is configured to stored the video data took by the first and second video cameras under the control of the controller.

4. The smart helmet of claim 2, further comprising a bone conduction inputting device, at least one bone conduction outputting device, and a wireless communication module electronically coupled to both the bone conduction inputting and outputting devices; wherein the bone conduction inputting device is configured to convert sound of the user wearing the smart helmet to be output into an electrical wave signal; the wireless communication module is configured to receive the electrical wave signal and transmit the electrical wave signal out and/or receive an external electrical wave signal; the bone conduction outputting device is configured to receive the external electrical wave signal sent by the wireless communication module, and covert the electrical wave signal into a vibrating wave which can be transmitted into ear of the user.

5. The smart helmet of claim 4, further comprising a band configured to fit around a jaw of the user; wherein two ends of the band is rotatably received into the internal cavity; the bone conduction inputting device is mounted on a substantially middle portion of the band; the bone conduction outputting device is positioned in the internal cavity adjacent to one of the two ends of the band.

6. The smart helmet of claim 4, further comprising a voice recognition module that is electronically coupled to the controller and the bone conduction inputting device; wherein the voice recognition module is configured to recognize commands contained in the electrical wave signals output from the bone conduction inputting device and transmit the commands to the controller; the controller is configured to execute the commands.

7. The smart helmet of claim of claim 1, further comprising a solar cell and a power managing unit electronically coupled to the solar cell, wherein the solar cell is mounted on an outer surface of the helmet shell, and is configured to convert solar power into electric power; the power managing unit is configured to receive the electric power, and convert the electric power into working voltages of electronic components of the smart helmet.

8. A smart helmet comprising:
a helmet shell defining an internal cavity configured to receive a user's head;
a band having two ends, each of the two ends rotatably within the internal cavity;
a bone conduction inputting device mounted onto the band and configured to convert sound of a user wearing the smart helmet into an electrical wave signal;
a wireless communication module configured to receive the electrical wave signal and transmit the electrical wave signal as an external electrical wave signal; and
a bone conduction outputting device positioned in the internal cavity adjacent to one or both of the two ends of the band, and configured to receive the external electrical wave signal sent by the wireless communication module and covert the external electrical wave signal into a vibrating wave which can be transmitted into an ear of the user.

9. The smart helmet of claim 8, further comprising a controller and a voice recognition module electronically coupled to the controller and the bone conduction inputting device; wherein the voice recognition module is configured to recognize commands contained in the electrical wave signals output from the bone conduction inputting device and transmit the commands to the controller; the controller is configured to execute the commands.

10. The smart helmet of claim 8, further comprising a visor and a projector mounted on the helmet shell, wherein the helmet shell further defines a passage communicating with the internal cavity; the visor is configured to expose or cover the passage; the projector is configured to introduce content for display onto the visor.

11. The smart helmet of claim 10, further comprising a controller electronically coupled to the projector and a global position system (“GPS”) navigation module electronically coupled to the controller, wherein the GPS navigation module is configured to generate navigation data of the smart helmet, and output the navigation data to the controller; the controller is configured to handing navigation content for display according to the navigation data, and output the navigation content for display to the projector.

12. The smart helmet of claim 11, further comprising a camera module that comprises a first video camera, a second video camera, and a memory, all of which are electronically coupled to the controller; wherein the first video camera is mounted on a front portion of the helmet shell, and configured to pick up scenes of the front of the helmet shell; the second video camera is mounted on a rear portion of the helmet shell, and configured to pick up scenes of the rear of the helmet shell; the memory is configured to stored the video data took by the first and second video cameras under the control of the controller.

13. The smart helmet of claim of claim 8, further comprising a solar cell and a power managing unit electronically coupled to the solar cell, wherein the solar cell is mounted on an outer surface of the helmet shell, and is configured to convert solar power into electric power; the power managing unit is configured to receive the electric power, and convert the electric power into working voltages of electronic components of the smart helmet.
